(19) United States
(12) Patent Application Publication
(10) Pub. No.: US 2013/0331963 A1
(43) Pub. Date: Dec. 12, 2013

(54) SYSTEMS, METHODS, AND SOFTWARE TO IDENTIFY AND PRESENT RELIABILITY INFORMATION FOR INDUSTRIAL AUTOMATION DEVICES

(71) Applicants: Abdolmehdi Kaveh Ahangar, Cedarburg, WI (US); David Yellamati, Mancherial (IN); Garron K. Morris, Whitefish Bay, WI (US)

(72) Inventors: Abdolmehdi Kaveh Ahangar, Cedarburg, WI (US); David Yellamati, Mancherial (IN); Garron K. Morris, Whitefish Bay, WI (US)

(73) Assignee: ROCKWELL AUTOMATION TECHNOLOGIES, INC., Mayfield Heights, OH (US)

(21) Appl. No.: 13/489,852

(22) Filed: Jun. 6, 2012

(51) Int. Cl. G05B 19/18; G06F 3/048

(52) U.S. Cl. 700/83; 715/781

(57) ABSTRACT

Systems, methods, and software for determining and visualizing reliability data for industrial automation equipment are provided herein. In one example, a non-transitory computer readable medium having stored thereon program instructions executable by a computing device is presented. When executed by the computing device, the program instructions direct the computing device to present a graphical user interface to receive a user selection for at least one operating parameter for the industrial automation device and identify a modified load profile based on at least a base load profile and the at least one operating parameter for the industrial automation device. The program instructions further direct the computing device to generate reliability information for the industrial automation device based on the modified load profile, and present an indication of the reliability information via the graphical user interface.

### TECHNICAL FIELD

Aspects of the disclosure are related to the field of industrial automation, and in particular, to software, systems, and methods for identifying and presenting reliability information for industrial automation devices and equipment.

### TECHNICAL BACKGROUND

Industrial automation environments can include various machine systems, industrial automation devices, and industrial processes, such as those found in factories, milling operations, manufacturing facilities, and the like. These machine systems and industrial automation devices typically include an operation or process implemented by a mechanical or electrical device. Specific examples of these devices and systems can include various functions of machinery associated with industrial automation including manufacturing equipment, assembly equipment, milling equipment, process equipment, and packaging equipment, or other machine systems.

As a specific example, many industrial automation devices include variable frequency drives (VFDs). These VFDs can be included in industrial automation devices to provide variable frequency alternating current (AC) power in order to drive and control motor equipment such as conveyors, fans, pumps, augers, mills, or other equipment. Various operating environments can be encountered by these VFDs, each with its own stresses, temperatures, pressures, or other environmental and operating conditions.

Prior to installation and active service of many of these industrial automation devices, such as VFDs, reliability studies are performed to establish expected lifetimes and predicted failures based on operational parameters, duty cycles, loading, and other factors. These reliability studies can indicate various indicators of reliability such as mean time between failures (MTBF) or times between a certain percentage of failures, such as L10 for 10% failures or L5 for 5% failures. The reliability studies are typically performed by engineers or technical experts using established reliability formulae and estimation techniques. Thus, allowing an end user or customer to perform reliability analysis has been difficult due to the complex technical details for establishing reliability in industrial automation devices.

### Overview

Systems, methods, and software for determining and visualizing reliability data for industrial automation equipment are provided herein. In a first example, a non-transitory computer readable medium having stored thereon program instructions executable by a computing device is presented. When executed by the computing device, the program instructions direct the computing device to present a graphical user interface to receive a user selection for at least one operating parameter for the industrial automation device and identify a modified load profile based on at least a base load profile and the at least one operating parameter for the industrial automation device. The program instructions further direct the computing device to generate reliability information for the industrial automation device based on the modified load profile, and present an indication of the reliability information via the graphical user interface.

In a second example, a method of generating load profile information for industrial automation equipment is presented. The method includes identifying a modified load profile based on at least a base load profile and a plurality of operating parameters for the industrial automation device, wherein the plurality of operating parameters are selected via a graphical user interface, generating reliability information for the industrial automation device based on the modified load profile, and presenting at least one indicator of the reliability information via the graphical user interface.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a reliability processing system.

FIG. 2 is a flow diagram illustrating a method of operation of a reliability processing system.

FIG. 3 is a system diagram illustrating a reliability processing environment.

FIG. 4 is a block diagram illustrating an example graphical user interface.

FIG. 5 is a system diagram illustrating a reliability processing system.

FIG. 6 is a flow diagram illustrating a method of operation of a reliability processing system.

FIG. 7 is a block diagram illustrating an example graphical user interface.

### DETAILED DESCRIPTION

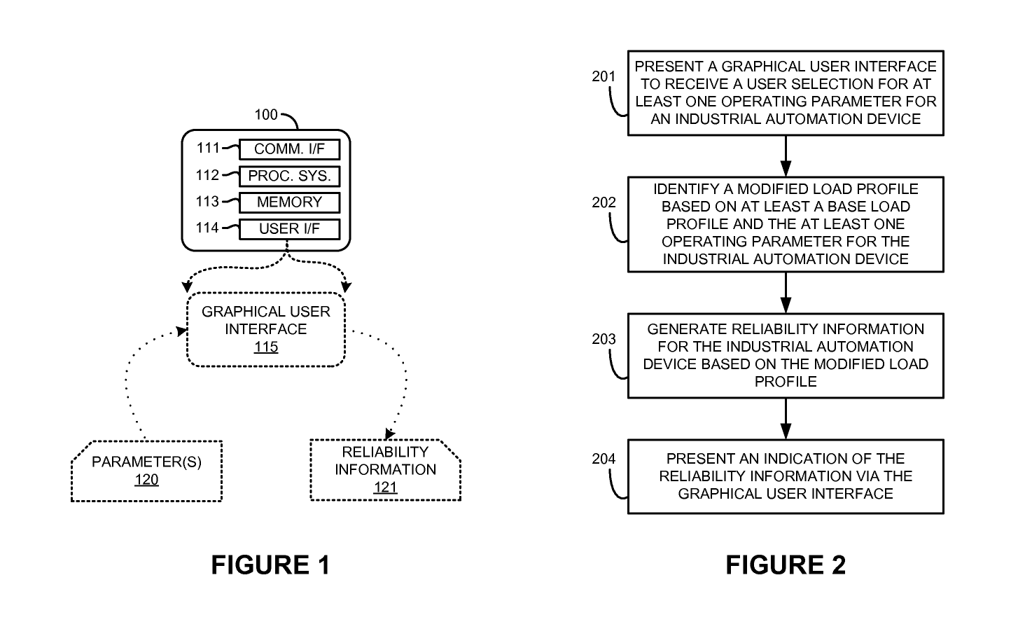

FIG. 1 is a system diagram illustrating reliability processing system 100. Reliability processing system 100 includes communication interface 111, processing system 112, memory 113, and user interface 114. In this example, user interface 114 presents graphical user interface 115. Graphical user interface 112 can receive user input for parameters 120 and present reliability information 121. In operation, processing system 112 is operatively linked to communication interface 111, memory 113, and user interface 114. Processing system 112 is capable of executing software stored in memory 113. When executing the software, processing system 112 drives reliability processing system 100 to operate as described herein.

FIG. 2 is a flow diagram illustrating a method of operation of reliability processing system 100. The operations of FIG. 2 are referenced herein parenthetically. In FIG. 2, reliability processing system 100 presents (201) graphical user interface 115 to receive a user selection for at least one operating parameter for an industrial automation device. The at least one operating parameter is indicated by parameters 120 in FIG. 1.

Reliability processing system 100 identifies (202) a modified load profile based on at least a base load profile and the at least one operating parameter for the industrial automation device. As discussed above, the at least one operating parameter is typically received as parameters 120 into graphical user interface 115. In some examples, further operating parameters can include default or predetermined values of operating parameters that are not modified by user input via parameters 120 but are still processed along with parameters 120 to determine a modified load profile.

A base load profile is determined for an industrial automation device, such as a VFD, by testing the device under a load profile that represents a worst-case application. Power cycling (on/off) and flying starts (starting into a pre-spinning motor) are typically applied during this testing. The worst-case application typically entails the application which experiences the highest magnitude stresses, shocks, ambient conditions, etc . . . , and the worst-case application can comprise a composite application combining worst-case conditions from many different applications. A base load profile is typically performed once for a particular device and stored for later usage, such as within memory 113 or external storage devices including servers, databases, or other computer-readable media.

Once a base load profile is determined, the base load profile can be modified or altered by parameters 120, among other parameters, to establish a modified load profile. Known reliability relationships and equations are employed to modify the base load profile into the modified load profile, such as the Arrhenius equation, to alter the base load profile by the user-input operating conditions or other operating conditions.

Reliability processing system 100 generates (203) reliability information for the industrial automation device based on the modified load profile. The reliability formation can include a numerical indicator of reliability, such as mean time between failures (MTBF), times between a certain percentage of failures, such as L10 for 10% failures or L5 for 5% failures, or confidence indicators of the estimated reliability information, among other numerical indicators. The reliability information can also include a graphical representation of reliability, such as a reliability curve.

Reliability processing system 100 presents (204) an indication of the reliability information via the graphical user interface. As discussed above, numerical and graphical reliability information/indicators can be determined. Numerical indicators can be presented via graphical user interface using a textual indicator, such as within a text box. The reliability curve can be presented via graphical user interface 115 as a two-dimensional graph which plots a relationship between time and reliability. More complex graphs can also be presented, such as multi-dimensional graphs which plot other reliability information against time or operating conditions. Numerical and graphical indicators can both be presented via graphical user interface 115.

Reliability processing system 100 can determine reliability for a specific industrial automation device. Reliability processing system 100 can indicate an industrial automation device or associated VFD suitable for the application/industry/parameters which produce the resultant reliability information. The industrial automation device can be indicated by model number, device model, device type, or can be identified by a range of device options which satisfy input criteria or reliability targets.

The operating parameters, environmental conditions, or other information can be input via graphical user interface 115 directly by user, or can be based on actual monitored conditions. For example, a modified load profile can be identified based on operating condition information determined by monitoring equipment of the industrial automation device. The industrial automation device or associated VFD can include monitoring equipment, such as data loggers, sensors, sensor systems, or other monitoring equipment to identify operating conditions and environmental conditions of the industrial automation device while in actual use. This information can be introduced into reliability processing system 100 to establish the reliability information, or can be introduced and altered by a user to establish the reliability information, including combinations thereof.

In further examples, a base reliability curve is established based on the base load profile or other information. This base reliability curve can illustrate reliability of an industrial automation device over time or versus other variables. The base reliability curve can be modified using the modified load profile to establish a modified reliability curve indicating reliability changed according to parameters 120 or other parameters. As a further example, reliability processing system 100 can identify a base reliability curve based on the base load profile for the industrial automation device, identify a modified reliability curve based on the base reliability curve and the modified load profile, and present the modified reliability curve via graphical user interface 115.

Referring back to FIG. 1, communication interface 111 may include communication connections and equipment that allows for communication with external systems and devices. Examples of communication interface 111 include network interface cards, wired interfaces, wireless interfaces, transceivers, antennas, power amplifiers, RF circuitry, optical networking equipment, and other communication circuitry.

Processing system 112 may be implemented within a single processing device but may also be distributed across multiple processing devices or sub-systems that cooperate in executing program instructions. Examples of processing system 112 include general purpose central processing units, microprocessors, application specific processors, and logic devices, as well as any other type of processing device.

Memory 113 may comprise any storage media readable by processing system 112 and capable of storing software. Memory 113 may include volatile and nonvolatile, removable and non-removable media implemented in any method or technology for storage of information, such as computer readable instructions, data structures, program modules, or other data. Memory 113 may be implemented as a single storage device but may also be implemented across multiple storage devices or sub-systems. Memory 113 may comprise additional elements, such as a controller, capable of communicating with processing system 112. Examples of storage media include random access memory, read only memory, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software stored on or in memory 113 may comprise computer program instructions, firmware, or some other form of machine-readable processing instructions having processes that when executed by processing system 112 direct reliability processing system 100 to operate as described herein. For example, software drives reliability processing system 100 to receive user input for parameters 120, process parameters 120 along with load profile information, and present reliability information 121, among other operations. The software may also include user software applications. The software may be implemented as a single application or as multiple applications. In general, the software may, when loaded into processing system 112 and executed, transform processing system 112 from a general-purpose device into a special-purpose device customized as described herein.

User interface 114 may have input devices such as a keyboard, a mouse, a voice input device, or a touch input device, and comparable input devices. Output devices such as a display, speakers, printer, and other types of output devices may also be included with user interface 114. For example, in FIG. 1, user interface 114 includes graphical user interface 115 for displaying and receiving reliability information and parameters. User interface 114 may also be considered to be an integration of reliability processing system 100 with software elements, such as operating system and application software. For instance, a user may navigate an application view using a user device, such as a touchpad, or place a voice call using a keypad. The interface functionality provided by the integration of user interface software with user interface devices can be understood to be part of user interface 114.

Graphical user interface 115 can include graphical and text-based user input elements, such as forms, slider bars, text boxes, buttons, radio buttons, check boxes, windows, icons, and pull-down menus, among other input elements, including combinations or variations thereof. Graphical user interface 115 can be presented in a spreadsheet, interactive web page, discrete application, mobile phone app, tablet device app, windowing environment, or other graphical environments.

Operating parameters included in parameters 120 can include any environmental or operational parameter for an industrial automation device or associated controller devices. Examples include industry, application within an industry, duty factors, overload expectations, shock expectations, speed parameters, acceleration parameters, power cycles, flying starts, temperature, altitude, humidity, vibration, and power quality, among other parameters, including combinations or variations thereof. Typically, different applications and industries operate these industrial automation devices under different operating conditions and stresses, such as ambient temperature, overloads, shock loads, and flying starts, among other stresses.

Example industrial automation devices can include an operation or process implemented by a mechanical or electrical device. Examples of industrial automation devices include various functions of machinery associated with industrial automation including manufacturing equipment, assembly equipment, packaging equipment, milling equipment, or other machine systems, including combinations thereof. Variable frequency drives (VFD) can be included in the industrial automation devices as controller devices to electrically control a frequency of electrical power supplied to a motor, and thus control a speed, torque, acceleration, direction, or other operations of a motor within an industrial automation device.

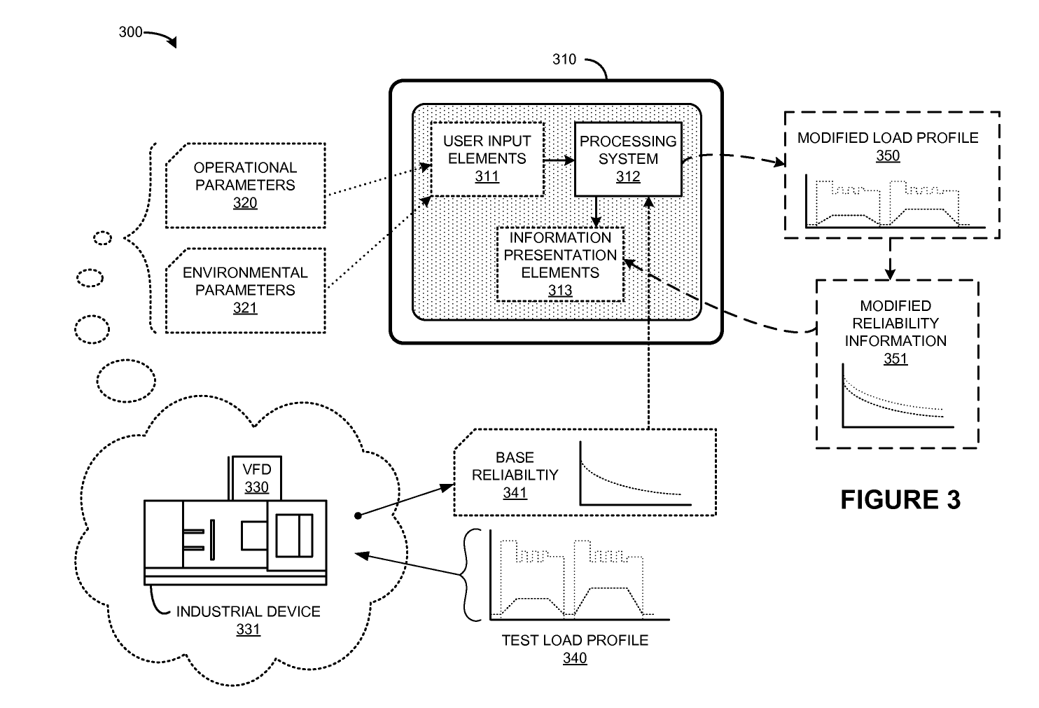

FIG. 3 is a system diagram illustrating reliability processing environment 300. Reliability processing environment 300 includes reliability processing system 310 which further includes user input elements 311, processing portion 312, and information presentation elements 313. User input elements 311 can receive user input such as operational parameters 320 and environmental parameters 321. Processing portion 312 can process information received through user input elements 311 along with base load profile 340 and other information to establish modified load profile 350 and reliability information 351. Information presentation elements 313 can present reliability information 351, along with other information, to a user of reliability processing system 310.

In this example, reliability processing system 310 is a computing device, such as a personal computer, laptop, tablet computing device, mobile smartphone, server, or other computing device which can receive user input and present a graphical user interface. Reliability processing system 310 can be an example of reliability processing system 100, although different configurations can be employed.

In operation, processing portion 312 will direct further portions of reliability processing system 310 to generate and present graphical user input elements 311, such performed by a display, audio device, screen, touchscreen, video processing portion, or other elements. In some examples, a web-based interface is presented over a network link for a web browser application of a user. User input elements 311 can include graphical user interface elements, such as graphical and text-based user input elements, including forms, slider bars, text boxes, buttons, radio buttons, check boxes, windows, icons, and pull-down menus, among other input elements, including combinations or variations thereof. The user input can be received over a plurality of input devices, such as a touchscreen, keyboard, keypad, mouse, pointer device, speech recognition elements, or other input equipment. User input elements 311 receives operational parameters 320 and environmental parameters 321 from a user of reliability processing system 310.

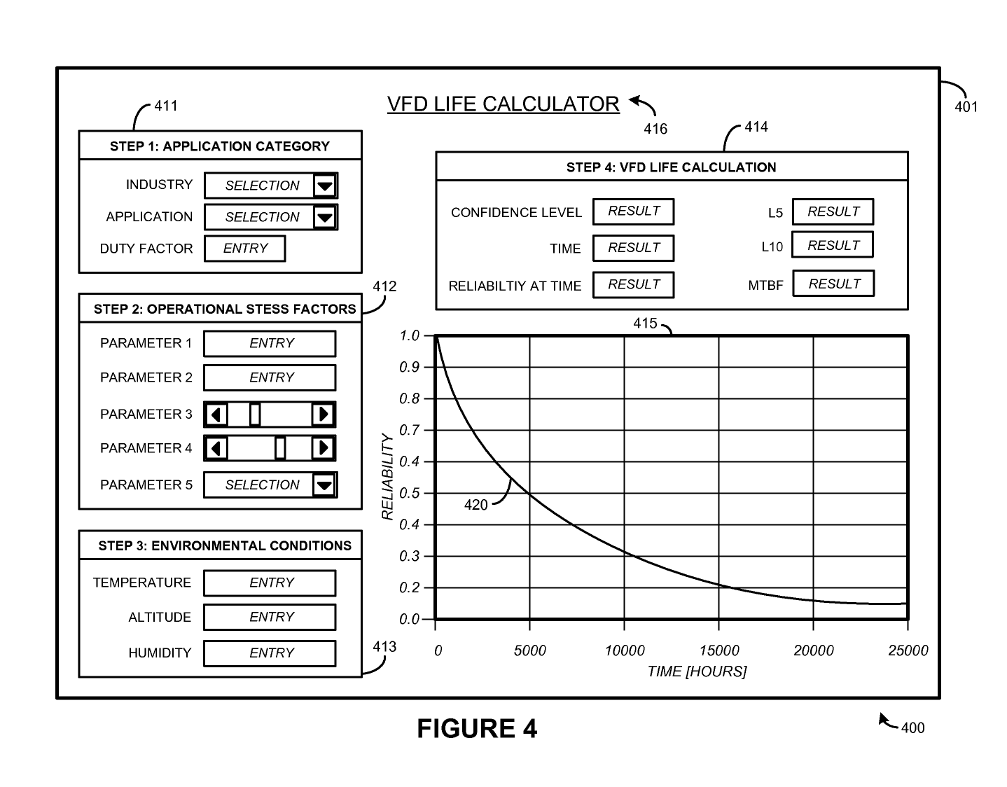

Once a user has completed input of operation parameters 320 and environmental parameters 321 via user input elements 311, processing portion 312 processes operation parameters 320 and environmental parameters 321 along with base load profile 340 to determine modified load profile 350 and reliability information 351. Other parameters can be included when determining modified load profile 350 or reliability information 351, such as default parameters, parameters unmodified by a user, constants, internal variables, or other parameters not input by a user. Various examples of this operation are discussed herein, and can include base load profile 340 being modified according to the user-input parameters based on reliability formulae and techniques. Modified load profile 350 is then processed to establish reliability information 351. Reliability information 351 is presented via graphical user interface elements of reliability processing system 310, which can be similar elements as employed for user input elements 311, or can also include graphs, plots, text fields, numerical indicators, or other graphical information presentation elements, as indicated by information presentation elements 313 in FIG. 3. Further examples of the user interface elements used for receiving operational parameters 320 and environmental parameters 321, and for displaying reliability information 351 are presented in FIG. 4.

Operational parameters 320 can include any operational parameter for an industrial automation device or associated controller or driver devices. Examples include industry, application within an industry, duty factors, overload expectations, shock expectations, speed parameters, acceleration parameters, power cycles, or flying starts, including combinations thereof. Environmental parameters 321 can include any environmental parameter for an industrial automation device or associated controller or driver devices. Examples include temperature, altitude, humidity, vibration, and power quality, among other parameters, including combinations or variations thereof. In this example, the operational parameters reflect an operating environment for industrial device 331 which is driven by VFD 330.

Different applications and industries employ industrial device 331 under different operating and environmental conditions, as indicated above. The industry typically indicates the general realm of use for the industrial automation equipment. Example industries include material handling, mining/cement, rubber/plastics, food/beverage, consumer goods, textiles, water/waste water, automotive, oil/gas, and pulp/paper, among other industries, including combinations thereof. The application typically indicates the specific type of function or process used by the industrial automation equipment. Example applications include belt conveyors, chain conveyors, diverters, palletizers, centrifugal fans/pumps, cooling/baking conveyors, positive displacement compressors, hoists, cranes, auger conveyors, ball mills, rotary kilns, induced draft fans, beater type mixers, crushers/pulverizers, extruders, blown film, injection molding, blow molding, screw compressors, center driven winders, sugar centrifuges, punch presses, textile machines, engine/transmission test stands, recirculation fans, compressors, chippers, mixers, flow/pumps, converting, and web handling, including combinations thereof.

Many industrial automation devices include variable frequency drives (VFDs). These VFDs provide variable frequency power to drive and control motor equipment. In this example, VFD 330 provides variable frequency alternating current (AC) power to industrial device 331. Industrial device 331 can include an operation or process implemented by a mechanical or electrical device. Examples of industrial device 331 include various functions of machinery associated with industrial automation including manufacturing equipment, assembly equipment, packaging equipment, milling equipment, presses, hydraulic equipment, industrial vehicles, vats, batch process equipment, tanks, fillers, sorters, scanning equipment, or other machine systems, including combinations thereof. Further examples of industrial device 331 include machine control systems, such as motor power controls, motor control centers, pump power controls, lathe machine speed controls, roller mechanism engagement systems, on/off functions of a manufacturing device, a lift function for a forklift, robotic arms, among other examples. Yet further examples of industrial device 331 include Rockwell Automation or other industrial automation and information products including operator interfaces, drives, motors, I/O modules, programmable controllers, circuit breakers, contactors, motor protectors, energy and power monitors, PowerFlex® drives, servo drives, servo motors, push buttons, signaling devices, relays, timers, switches, or safety devices.

FIG. 4 is a block diagram illustrating example graphical user interface (GUI) 400. Graphical user interface 400 can be employed in the examples of reliability processing systems presented herein, although other configurations can be employed. In this example, GUI 400 is presented to calculate reliability and lifetime information for a variable frequency drive (VFD) portion of an industrial automation device, as indicated by title 416. GUI 400 includes main window 401 which includes various further GUI elements. These elements include application entry portion 411, operational parameter entry portion 412, environmental parameter entry portion 413, reliability indicator portion 414, reliability graph 415, and title 416. Although GUI 400 illustrates a specific example of a graphical user interface presented to a user for receiving user input and presenting reliability data, it should be understood that other representations can be employed. Graphical user interface 400 can be presented in a spreadsheet, interactive web page, discrete application, mobile phone app, tablet device app, windowing environment, or other graphical environments.

Elements 411-416 are presented to a user via a graphical or video display on a computing device, such as those found in the examples herein. Element 411 presents various options for general operating conditions for the VFD (or associated industrial automation device) of interest, namely industry, application, and duty factor. Application and industry selections are presented in pull-down selection elements, while duty factor is presented in a text field. Element 412 presents various options for operational stress factors that the VFD of interest will likely experience during use. These include 5 parameters in this example, and can be any of the operational parameters discussed herein presented to the user in a variety of graphical user input element types, such as text fields, pull-down selections, slider bars, or other types. Element 413 presents various options for environmental conditions expected to be experienced by the VFD of interest, namely temperature, altitude, humidity, or other parameters. Elements 411-413 can include any operational or environmental parameters such as discussed in FIGS. 1 and 3.

Once a user has input various application, operational, and environmental parameters into GUI 400, reliability and lifetime information can be determined for the VFD. This determination proceeds according to that discussed herein, and can be a real-time calculation responsive to each parameter being input by a user, or can be initiated by a trigger event or trigger button in further examples. This reliability information is presented via elements 414 and 415.

Element 414 includes various results for VFD life calculations, namely a confidence level of the calculations, a L5 lifetime, a L10 lifetime, and a MTBF figure. Additionally, a time and a reliability at said time are presented in element 414 which correspond to reliability graph 415. A user can click or select a point in graph 415 and the corresponding information is presented in the time and reliability at said time portions of element 414. These portions correspond to coordinates of graph 415 that lie along reliability curve 420.

Element 415 is a graph that illustrates reliability curve 420. Reliability curve 420 relates a reliability on the vertical axis to a time on the horizontal axis. Reliability curve 420 is determined based on the parameters input via elements 411-413, and reflects the results presented in element 414. Although element 415 is shown as a two-dimensional graph in this example, it should be understood that element 415 can instead include a different style of graph, such as a bar graph, histogram, pie chart, or multi-dimensional representation.

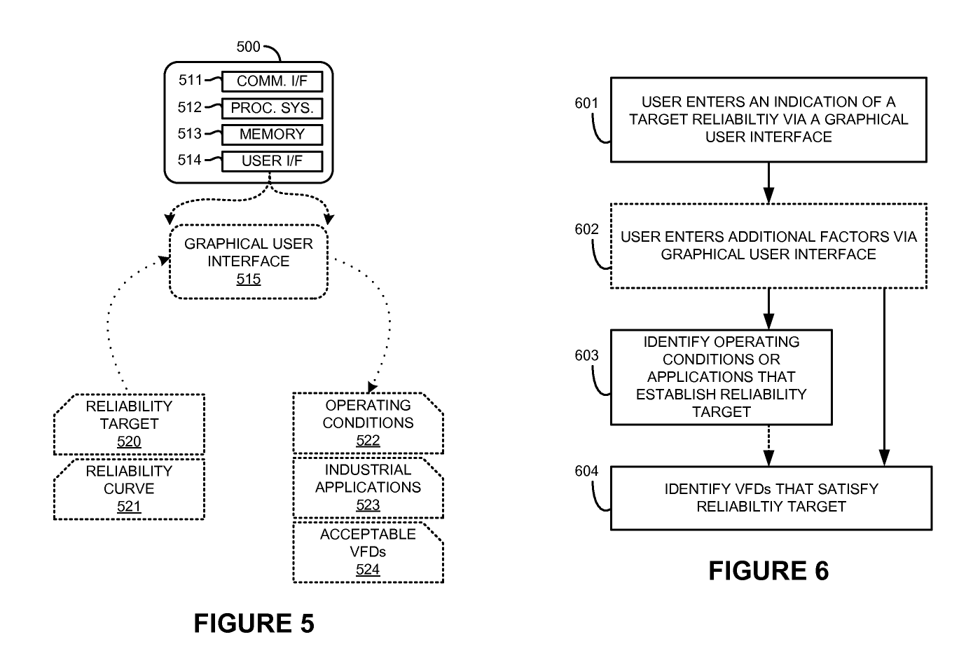

FIG. 5 is a system diagram illustrating reliability processing system 500. Reliability processing system 500 includes communication interface 511, processing system 512, memory 513, and user interface 514. In this example, user interface 514 presents graphical user interface 515. Graphical user interface 515 can receive user input for reliability target 520, reliability curve 521, and presents operating parameters 522, industrial applications 523, and acceptable VFDs 524. In operation, processing system 512 is operatively linked to communication interface 511, memory 513, and user interface 514. Processing system 512 is capable of executing software stored in memory 513. When executing the software, processing system 512 drives reliability processing system 500 to operate as described herein.

Communication interface 511 may include communication connections and equipment that allows for communication with external systems and devices. Examples of communication interface 511 include network interface cards, wired interfaces, wireless interfaces, transceivers, antennas, power amplifiers, RF circuitry, optical networking equipment, and other communication circuitry.

Processing system 512 may be implemented within a single processing device but may also be distributed across multiple processing devices or sub-systems that cooperate in executing program instructions. Examples of processing system 512 include general purpose central processing units, microprocessors, application specific processors, and logic devices, as well as any other type of processing device.

Memory 513 may comprise any storage media readable by processing system 512 and capable of storing software. Memory 513 may include volatile and nonvolatile, removable and non-removable media implemented in any method or technology for storage of information, such as computer readable instructions, data structures, program modules, or other data. Memory 513 may be implemented as a single storage device but may also be implemented across multiple storage devices or sub-systems. Memory 513 may comprise additional elements, such as a controller, capable of communicating with processing system 512. Examples of storage media include random access memory, read only memory, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software stored on or in memory 513 may comprise computer program instructions, firmware, or some other form of machine-readable processing instructions having processes that when executed by processing system 512 direct reliability processing system 500 to operate as described herein. For example, software drives reliability processing system 500 to receive reliability target information from a user, namely reliability target 520 or reliability curve 521, process the reliability target information along with load profile information, and present operating parameters, suitable applications, or acceptable VFDs based on the user-specified reliability target information. The software may also include user software applications. The software may be implemented as a single application or as multiple applications. In general, the software may, when loaded into processing system 512 and executed, transform processing system 512 from a general-purpose device into a special-purpose device customized as described herein.

User interface 514 may have input devices such as a keyboard, a mouse, a voice input device, or a touch input device, and comparable input devices. Output devices such as a display, speakers, printer, and other types of output devices may also be included with user interface 514. For example, in FIG. 5, user interface 514 includes graphical user interface 515 for displaying and receiving reliability information and parameters. User interface 514 may also be considered to be an integration of reliability processing system 500 with software elements, such as operating system and application software. For instance, a user may navigate an application view using a user device, such as a touchpad, or place a voice call using a keypad. The interface functionality provided by the integration of user interface software with user interface devices can be understood to be part of user interface 514.

FIG. 6 is a flow diagram illustrating a method of operation of a reliability processing system 500. The operations of FIG. 6 are referenced herein parenthetically. Generally, FIG. 6 describes a somewhat reverse operation as described in FIGS. 1-3, where a user inputs a reliability target or other reliability information, and reliability processing system 500 identifies and presents suitable operating conditions or industry/applications for an industrial automation device or VFD of interest.

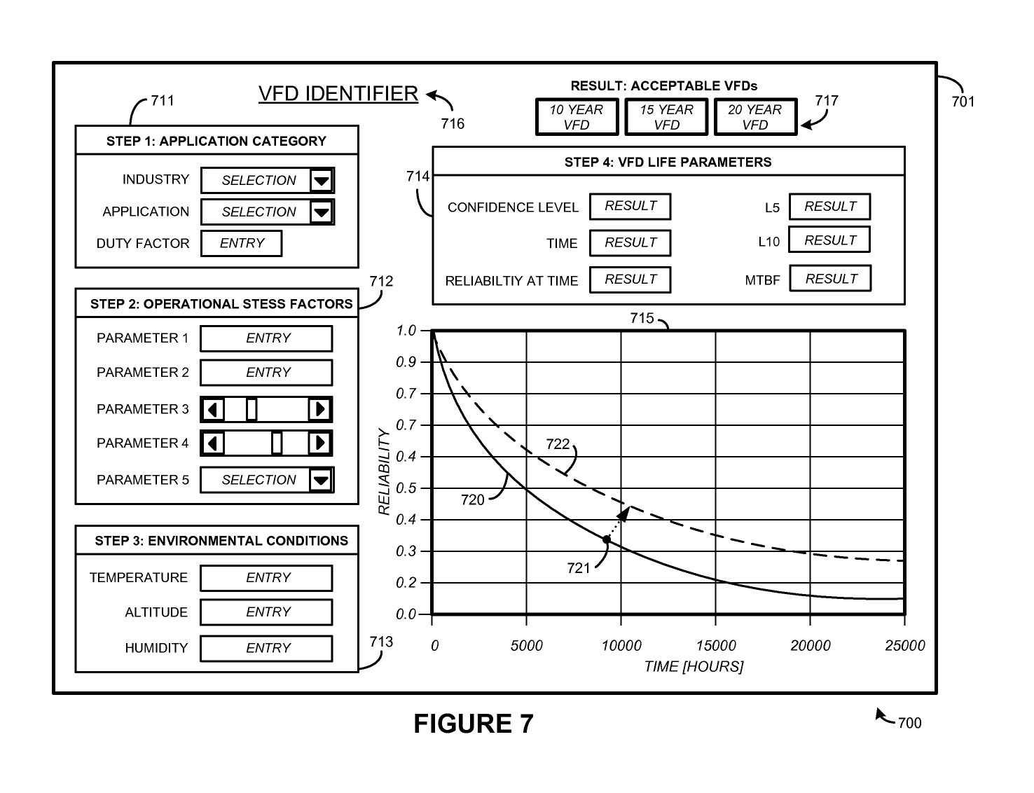

More specifically, in FIG. 6, a user enters (601) an indication of a target reliability via graphical user interface 515. Graphical user interface 515 presents various graphical user interface elements to a user, such as those found in elements 411-416 of FIG. 4 or elements 711-717 of FIG. 7. The user can then input or alter the various reliability indicators or alter the reliability graph presented in these graphical elements. These target reliability indicators are represented by reliability target 520 and reliability curve 521 in FIG. 5.

In one example, a user can input a reliability numerical target indicated by reliability target 520, such as a MTBF, L5, L10, or other reliability indicator into GUI 515. Reliability target 520 can be entered into a text field, or other graphical input element, such as those found in element 414 of FIG. 4 or 714 of FIG. 7. In another example, a user can input a reliability target curve indicated by reliability curve 521. Reliability curve 521 can be input by altering a pre-existing reliability curve, or by specifying a new curve, such as by drawing with an input device. For example, FIG. 7 illustrates reliability curve 720 being altered by user operation 721 into altered reliability curve 722. Operation 721 can be a click-and-drag operation or a double-click on a target point in graph 715, among other user selection or alteration operations. In further examples, a user can draw or gesture a reliability curve as reliability curve 721 using a user input device, such as a mouse or touchpad.

The user can also optionally enter (602) additional factors via graphical user interface 515. These additional factors can include the various application, operating, or industrial automation environment parameters discussed herein. For example a user can input a reliability target along with specifying some of the parameters normally entered in elements 411-413 of FIG. 4 or 711-713 of FIG. 7. The user can then leave some of the parameters without user input which can then be altered in operation 603. Thus, reliability processing system 500 provides an interactive reliability presentation experience to a user. A user can initially specify reliability targets, operating conditions, or industry/application parameters to determine suitable VFDs or other industrial automation devices. The user can also specify a target reliability to determine operating conditions or industry/application suitable for the target reliability for the industrial automation device.

Reliability processing system 500 identifies (603) operating conditions or applications that establish the reliability target. Once the reliability target or other parameters are entered by the user, a load profile, reliability information, along with various operating parameters are processed to determine suitable applications, industries, or other operating parameters for the industrial automation device. Reliability formulae or calculation techniques used to determine a reliability factor or curve can be employed in a reverse manner with a reliability target as an input condition and having various operating conditions or industry/application as resultant output information.

Reliability processing system 500 identifies (604) VFDs that satisfy the reliability target of operation 601. A listing or selection of various VFDs can be presented via the graphical user interface. Although a single VFD can be identified, in some examples multiple VFDs are identified. The multiple VFDs can be organized or presented according to an estimated operational lifetime based on the reliability targets or additional factors entered during operations 601-602. Thus, in response to graphical user interface 515 receiving the user input, reliability processing system 500 selects from a plurality industrial automation devices at least one industrial automation device that satisfies at least the reliability target, and presents a representation of the at least one industrial automation device via the graphical user interface 515. Optionally, as discussed in operation 602, reliability processing system 500 can also present graphical user interface 515 configured to receive user input for at least one operating parameter applicable to the industrial automation environment, where at least one industrial automation device is selected that satisfies the reliability target and based on the at least one operating parameter.

Additionally, an iterative process can be established by reliability processing system 500, such that a user can specific input operating or environmental parameters to identify a reliability, and then the reliability can be subsequently altered by a user to adjust the suitable operating or environmental conditions. Further analysis can be performed to identify operating or environmental conditions that do not meet desired reliability targets. For example, reliability processing system 500 can identify at least one altered operating parameter for the industrial automation device based on at least the modified load profile and further user input that alters the indication of the reliability information, where the further user input is received via graphical user interface 515 to alter the indication of the reliability information, and present via graphical user interface 515 an indication of at least a first operating parameter for the industrial automation device that exceeds an operating threshold for the industrial automation device. In another example, reliability processing system 500 can identify at least one limiting operating parameter which reduces the reliability information to below a threshold reliability, present an indication of the at least one limiting operating parameter via graphical user interface 515, and alter the reliability information to being above the threshold reliability based on further user input received via the graphical user interface for the at least one limiting operating parameter. In yet another example, reliability processing system 500 can identify at least one altered operating parameter for the industrial automation device based on at least the modified load profile and an altered shape of the reliability curve, where further user input is received via graphical user interface 515 to alter the reliability curve by receiving an indication of the altered shape of the reliability curve, and present via graphical user interface 515 an indication of at least one operating parameter for the industrial automation device that exceeds an operating threshold for the industrial automation device.

In further examples, reliability processing system 500 can select another industrial automation device based on an alteration of a reliability curve or modification of a reliability target. In yet further examples, a modified reliability curve can be identified based on a base reliability curve modified by a target reliability. An industrial automation device can then be selected that satisfies at least the modified reliability curve. Reliability processing system 500 can present the modified reliability curve via the graphical user interface.

Reliability processing system 500 can identify at least another industrial automation device based on at least further user input that alters a reliability target, where the further user input is received via the graphical user interface after the representation of the at least one industrial automation device is presented. Reliability processing system 500 can identify at least one further industrial automation device which is excluded from the initially selected industrial automation devices due to the reliability target being below a threshold reliability. Reliability processing system 500 can present an indication of a reduced reliability target via the graphical user interface that would include at least one further industrial automation device. Reliability processing system 500 can present graphical user interface 515 configured to receive user input for at least one operating parameter applicable to the industrial automation environment, where at least one industrial automation device is selected that satisfies the reliability target and the at least one operating parameter. Reliability processing system 500 can then identify at least one further industrial automation device which is excluded from the selected industrial automation devices or device list due to the at least one operating parameter. Reliability processing system 500 can present an indication of at least one altered operating parameter via graphical user interface 515 that would include the at least one further industrial automation device in the selected industrial automation devices.

FIG. 7 is a block diagram illustrating example graphical user interface (GUI) 700. Graphical user interface 700 can be employed in the examples of reliability processing systems presented herein, although other configurations can be employed. In this example, GUI 700 is presented to identify acceptable variable frequency drives (VFDs) or other portions of industrial automation devices, as indicated by title 716. GUI 700 includes main window 701 which includes various further GUI elements. These elements include application entry portion 711, operational parameter entry portion 712, environmental parameter entry portion 713, reliability indicator portion 714, reliability graph 715, title 716, and acceptable VFD portion 717. Although GUI 700 illustrates a specific example of a graphical user interface presented to a user for receiving user input and presenting reliability data, it should be understood that other representations can be employed. Graphical user interface 700 can be presented in a spreadsheet, interactive web page, discrete application, mobile phone app, tablet device app, windowing environment, or other graphical environments.

Elements 711-717 are presented to a user via a graphical or video display on a computing device, such as those found in the examples herein. Element 711 presents various options for general operating conditions for the VFD (or industrial automation device) of interest, namely industry, application, and duty factor. Application and industry selections are presented in pull-down selection elements, while duty factor is presented in a text field. Element 712 presents various options for operational stress factors that the VFD of interest will likely experience during use. These include 5 parameters in this example, and can be any of the operational parameters discussed herein presented to the user in a variety of graphical user input element types, such as text fields, pull-down selections, slider bars, or other types. Element 713 presents various options for environmental conditions expected to be experienced by the VFD of interest, namely temperature, altitude, humidity, or other parameters. Elements 711-713 can include any operational or environmental parameters such as discussed in FIGS. 1 and 3.

Once a user has input various reliability targets or optionally various application, operational, and environmental parameters into GUI 700, suitable VFDs can be presented. This determination proceeds according to that discussed herein, and can be a real-time calculation responsive to each parameter being input by a user, or can be initiated by a trigger event or trigger button in further examples. This reliability information is entered or presented via elements 714 and 715. Acceptable VFDs are presented via element 717.

Element 714 includes various entries for VFD life calculations, namely a confidence level of the calculations, a L5 lifetime, a L10 lifetime, and a MTBF figure. Additionally, a time and a reliability at said time are presented in element 714 which correspond to reliability graph 715. A user can click or select a point in graph 715 and the corresponding information is transferred to associated portions of element 714 for entry of a reliability target. These portions can correspond to coordinates of graph 715 that lie along reliability curve 720.

Element 715 is a graph that illustrates reliability curve 720. Reliability curve 720 relates a reliability on the vertical axis to a time on the horizontal axis. Reliability curve 720 is determined based on the parameters input via elements 711-713, and reflects the results presented or input via element 714.

Element 715 also includes functionality to allow a user of GUI 700 to alter reliability curve 720, as indicated user operation 721 followed by altered reliability curve 722. Altered reliability curve 722 can allow a user to specify a desired or target reliability in a graphical fashion. The parameters presented in elements 711-713 can be responsively altered based on the altered reliability curve 722 to illustrate what parameters may need to be to establish reliability as indicated by altered reliability curve 722. A further discussion of this alteration process is discussed above in FIGS. 5-6. Although element 715 is shown as a two-dimensional graph in this example, it should be understood that element 715 can instead include a different style of graph, such as a bar graph, histogram, pie chart, or multi-dimensional representation.

Element 717 indicates three acceptable VFDs according to the input application parameters, operational and environmental factors, as well as any desired reliability targets input via elements 714-715. For example, a user can indicate a desired reliability target via text input in elements 714 or by altering or dragging graph 720 via operation 721. The operational and environmental parameters can also be included in determining acceptable VFDs which meet the reliability targets for the set of operational and environmental parameters. In this example, three VFDs are listed in element 717 according to expected or estimated operational lifetimes. Thus, a first acceptable VFD is listed for a 10 year estimated lifetime, a second acceptable VFD is listed for a 15 year estimated lifetime, and a third acceptable VFD is listed for a 20 year estimated lifetime. The same VFD or different VFDs can be included for individual results.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A non-transitory computer readable medium having stored thereon program instructions executable by a computing device that, when executed by the computing device, direct the computing device to:
present a graphical user interface to receive a user selection for at least one operating parameter for an industrial automation device;
identify a modified load profile based on at least a base load profile and the at least one operating parameter for the industrial automation device;
generate reliability information for the industrial automation device based on the modified load profile; and
present an indication of the reliability information via the graphical user interface.

2. The non-transitory computer readable medium of claim 1, wherein the reliability information comprises at least one of an L5 lifetime indicator, an L10 lifetime indicator, and a mean time between failures (MTBF) indicator for the industrial automation device.

3. The non-transitory computer readable medium of claim 1, wherein the modified load profile is further identified based on operating condition information determined by monitoring equipment of the industrial automation device.

4. The non-transitory computer readable medium of claim 1, wherein the at least one operating parameter comprises at least one of an environmental parameter, an operational stress parameter, an industry for the industrial automation device, and an application within the industry.

5. The non-transitory computer readable medium of claim 1 having further instructions stored thereon, that when executed, perform the steps of:
identify at least one altered operating parameter for the industrial automation device based on at least the modified load profile and further user input that alters the indication of the reliability information, wherein the further user input is received via the graphical user interface to alter the indication of the reliability information; and
present via the graphical user interface an indication of at least a first operating parameter for the industrial automation device that exceeds an operating threshold for the industrial automation device.

6. The non-transitory computer readable medium of claim 1 having further instructions stored thereon, that when executed, perform the steps of:
identify at least one limiting operating parameter which reduces the reliability information to below a threshold reliability;
present an indication of the at least one limiting operating parameter via the graphical user interface; and
alter the reliability information to being above the threshold reliability based on further user input received via the graphical user interface for the at least one limiting operating parameter.

7. The non-transitory computer readable medium of claim 1 having further instructions stored thereon, that when executed, perform the steps of:
present at least a graphical representation of a reliability curve via the graphical user interface to indicate the reliability information, wherein the reliability curve is determined based on a base reliability curve modified by the modified load profile.

8. The non-transitory computer readable medium of claim 7 having further instructions stored thereon, that when executed, perform the steps of:
identify at least one altered operating parameter for the industrial automation device based on at least the modified load profile and an altered shape of the reliability curve, wherein further user input is received via the graphical user interface to alter the reliability curve by receiving an indication of the altered shape of the reliability curve; and
present via the graphical user interface an indication of at least one operating parameter for the industrial automation device that exceeds an operating threshold for the industrial automation device.

9. The non-transitory computer readable medium of claim 1 having further instructions stored thereon, that when executed, perform the steps of:
identify a base reliability curve based on the base load profile for the industrial automation device;
identify a modified reliability curve based on the base reliability curve and the modified load profile; and
present the modified reliability curve via the graphical user interface.

10. The non-transitory computer readable medium of claim 1, wherein identifying the base load profile for the industrial automation device comprises:
determining a worst case load profile for the industrial automation device based on a plurality of operating conditions, testing the industrial automation device based on the worst case load profile, and identifying the base load profile based on the testing of the industrial automation device under the worst case load profile.

11. A method of generating load profile information for industrial automation equipment, the method comprising:
identifying a modified load profile based on at least a base load profile and a plurality of operating parameters for the industrial automation device, wherein the plurality of operating parameters are selected via a graphical user interface;
generating reliability information for the industrial automation device based on the modified load profile; and
presenting at least one indicator of the reliability information via the graphical user interface.

12. The method of claim 11, wherein the reliability information comprises at least one of an L5 lifetime indicator, an L10 lifetime indicator, and a mean time between failures (MTBF) indicator for the industrial automation device.

13. The method of claim 11, wherein the modified load profile is further identified based on operating condition information determined by monitoring equipment of the industrial automation device.

14. The method of claim 11, wherein the plurality of operating parameters comprise at least one of an environmental parameter, an operational stress parameter, an industry for the industrial automation device, and an application within the industry.

15. The method of claim 11, further comprising:
identifying at least one altered operating parameter for the industrial automation device based on at least the modified load profile and further user input, wherein the further user input is received via the graphical user interface to alter the indication of the reliability information; and
presenting via the graphical user interface an indication of at least one operating parameter for the industrial automation device that exceeds an operating threshold for the industrial automation device.

16. The method of claim 11, further comprising:
identifying at least one limiting operating parameter which reduces the reliability information to below a threshold reliability;
presenting an indication of the at least one limiting operating parameter via the graphical user interface; and
altering the reliability information to being above the threshold reliability based on receiving further user input for the at least one limiting operating parameter.

17. The method of claim 11, wherein presenting the indication of the reliability information via the graphical user interface comprises presenting at least a graphical representation of a reliability curve via the graphical user interface to indicate the reliability information, wherein the reliability curve is determined based on a base reliability curve modified by the modified load profile.

18. The method of claim 17, further comprising:
identifying at least one altered operating parameter for the industrial automation device based on at least the modified load profile and an altered shape of the reliability curve, wherein further user input is received via the graphical user interface to alter the reliability curve by receiving an indication of the altered shape of the reliability curve; and
presenting via the graphical user interface an indication of at least one operating parameter for the industrial automation device that exceeds an operating threshold for the industrial automation device.

19. The method of claim 11, further comprising:
identifying a base reliability curve based on the base load profile for the industrial automation device;
identifying a modified reliability curve based on the base reliability curve and the modified load profile; and
presenting the modified reliability curve via the graphical user interface.

20. The method of claim 11, wherein identifying the base load profile for the industrial automation device comprises:
determining a worst case load profile for the industrial automation device based on a plurality of operating conditions, testing the industrial automation device based on the worst case load profile, and identifying the base load profile based on the testing of the industrial automation device under the worst case load profile.
